(19) United States
(12) Patent Application Publication
(10) Pub. No.: US 2025/0178064 A1
(43) Pub. Date: Jun. 5, 2025

(54) APPARATUS AND METHOD TO COLLECT PRODUCTS, IN PARTICULAR METAL PRODUCTS, FROM A WORK MACHINE

(71) Applicant: M.E.P. MACCHINE ELETTRONICHE PIEGATRICI S.P.A., Reana Del Rojale (IT)

(72) Inventor: Giorgio Del Fabro, Udine (IT)

(73) Assignee: M.E.P. MACCHINE ELETTRONICHE PIEGATRICI S.P.A., Reana Del Rojale (IT)

(21) Appl. No.: 18/834,527

(22) PCT Filed: Jan. 31, 2023
(86) PCT No.: PCT/IT2023/050025

§ 371 Date: Jul. 30, 2024

(30) Foreign Application Priority Data
Jan. 31, 2022 (IT) 102022000001514

(51) Int. Cl. B21D 43/20; B23Q 1/01; B23Q 7/04

(52) U.S. Cl. CPC B21D 43/20; B23Q 1/012; B23Q 7/043

(57) ABSTRACT

Apparatus (10) for the collection of products, in particular metal products (11), from a work machine (12) provided with a zone (13) for the transfer of said metal products (11) from a work plane (14) to a zone outside said work machine (12).

### FIELD OF APPLICATION

The present invention refers to an apparatus and to a method to collect products, in particular metal products, such as clamps or the like, from a work machine, such as for example a clamping-shaping machine.

Although the invention is described with particular reference to the collection of clamps from a clamping-shaping machine, it could also be used for the collection of other metal and non-metal, shaped and not shaped products.

### BACKGROUND ART

As is known, there are clamping-shaping machines configured to produce clamps and/or profiles of various shape and size starting from one or more rolls or pre-cut bars in metal material.

Such clamps and/or profiles find particular application for forming reinforcement elements in the construction sector.

Such machines generally also have a transfer zone provided with a downwardly inclined plane conveying clamps and/or profiles towards the lower part of the machine. Subsequently, such clamps can be picked up by a forklift, by the operator or by other picking and transport mean.

The collection of the clamps leaving the machine is therefore an inefficient, disorderly operation and leads to the need to transfer the clamps on a forklift or similar to evacuate them from the work area around the machine.

The steps of collecting the known clamps may therefore involve using bulky collection means which may interfere with the work area of the machine, normally entail the presence of electrical power cables placed on the ground and can also involve using excessive spaces for their correct operation.

There is therefore the need to improve an apparatus and a method to collect products, in particular metal products, such as clamps, profiles or the like, from a work machine that can overcome at least one of the drawbacks of the technique.

In particular, an object of the present invention is to realize an apparatus for the collection of products, in particular metal products, such as clamps or the like, from a work machine that is efficient, not very bulky and by means of which said products can be transferred directly to a forklift or other transport mean, avoiding picking them up from the ground or in any case from a very low position, or other intermediate operations.

A further object of the present invention is to realize an apparatus for the collection of products that is simple, avoids the presence of power cables or other bulky elements in the work area of the machine and does not interfere with said work area.

A further object of the present invention is to realize an apparatus for the collection of products that is provided with great stability, therefore it can be used for metal products of various formats, both in terms of shape and sizes.

A further object of the present invention is to realize an apparatus for the collection of products that is independent of the work machine to which it is interlocked, therefore not affected for example by vibrations transmitted by the machine or other.

A further object of the invention is to devise an effective and simple method to collect products from a work machine.

The Applicant has studied, tested and realized the present invention to overcome the drawbacks of the prior art, and to obtain the above as well as further objects and benefits.

### DISCLOSURE OF THE INVENTION

The present invention is expressed and characterized in the independent claims. The dependent claims show other features of the present invention or variants of the main solution proposed.

In accordance with the aforementioned objects, the present invention concerns an apparatus for the collection of products, in particular metal products, from a work machine, wherein said machine is provided with a transfer zone for the transfer of said metal products from a work plane to a zone outside said machine.

The apparatus comprises at least one device for collecting said metal products which is hanging from a portal type support structure, wherein the collection device is provided with one or more arms configured to pick up the metal products directly from said transfer zone of the machine and transfer them to a forklift or other transport or movement mean.

In particular, the collection device can move along an upper crosspiece of said portal support structure, in order to run from a rest position to an operating position directly facing and cooperating with the transfer zone of the work machine.

The present apparatus, being provided with said collection device which is hanging from said support structure, proves extremely efficient, not bulky, does not require cables or power wires placed on the ground, can easily be positioned in the correct working and transfer positions without hindrances for the operator, is versatile in that it adapts to any type of shape and size of the clamp or profile and it is also economical both in terms of construction costs and operating costs.

The metal products can be transferred directly from said transfer zone of the machine to said forklift truck or other transport mean, avoiding picking them up from the ground or other intermediate operations.

Thanks to said portal support structure, this apparatus is also provided with great stability, therefore it can be used for metal products of various weights and formats.

In addition, the present apparatus is totally independent of the work machine to which it is interlocked for the collection of products, therefore it is not affected by the vibrations of the machine or other.

According to a further aspect of the invention, said portal support structure comprises at least two columns and a crosspiece from which said collection device is hung.

According to a further aspect of the invention, said collection device comprises a support mobile along a substantially vertical guide connected to said crosspiece. According to a further aspect of the invention, said guide is mobile in a substantially horizontal direction along said crosspiece.

According to a further aspect of the invention, said collection device comprises a plurality of sections articulated by means of rotation pins, configured to allow said collection device to assume several positions with various inclinations.

According to a further aspect of the invention, said support structure comprises at least a first lateral zone in which said collection device can be taken offline, that is, into a non-operating condition.

According to a further aspect of the invention, said support structure comprises at least a second lateral zone from which it is possible to unload said metal products directly onto said forklift or other transport or transfer mean.

According to a further aspect of the invention, said support structure comprises one or more elements for the cantilevered support of one or more collection devices.

According to a further aspect of the invention, said collection device is robotised and is connected to a control unit, so as to be able to automate the apparatus.

According to a further aspect of the invention, said support structure has a variable height.

According to a further aspect of the invention, said support structure comprises an overhead rail conveyor on which one or more collection devices are positioned, which are configured to collect said metal products from a first loading zone located in proximity to said transfer zone, unload them in an unloading zone located in proximity to said forklift, or other transport or movement mean, and then return toward said transfer zone.

According to a further aspect of the invention, said overhead rail conveyor is annular and substantially defined by at least one pair of crosspieces of said support structure connected by means of curved segments.

A further object of the invention is a method to collect metal products from a work machine, comprising the direct collection of said metal products from a transfer zone of the work machine, by means of one or more forks provided in at least one collection device which is hanging from a portal support structure of a collection apparatus and the transfer of said metal products from said collection device to a forklift or other transport or transfer mean, preferably without the metal products being placed on the ground, therefore without generating encumbrances in the work areas and requiring a subsequent collection step.

### ILLUSTRATION OF THE DRAWINGS

These and other aspects, features and advantages of the present invention will become clear from the following disclosure of embodiments, provided merely by way of non-limiting example only, with reference to the accompanying drawings in which:

FIG. 1 is a schematic side view of an apparatus for the collection of metal products, such as clamps or the like, from a work machine for working said metal products;

FIG. 2 is a front view of the present apparatus provided with a collection device illustrated offline, that is in a non-operating position;

FIG. 3 is a further front view of the collection device illustrated in line, that is, in the operating position;

FIG. 4 is a further front view of a step of transferring a metal product onto a forklift truck;

FIG. 5 is a further side view of the present apparatus;

FIG. 6 is a schematic plan view of a variant of the present apparatus.

It should be noted that, in the present disclosure, the phraseology and terminology used, as well as the figures in the accompanying drawings, even as disclosed, have the sole purpose of illustrating and explaining the present invention, since their function is illustrative and not limited to the invention itself, the scope of protection thereof being defined by the claims.

To facilitate understanding, identical reference numbers have been used, where possible, to identify identical common elements in the figures. It should be noted that elements and features of an embodiment can be conveniently combined or incorporated into other embodiments without further clarification.

### DETAILED DESCRIPTION OF CERTAIN EMBODIMENTS

Detailed reference will now be made to the possible embodiments of the invention, one or more instances of which are shown in the attached figures by way of example only. The phraseology and terminology used herein is also exclusively for illustrative purposes.

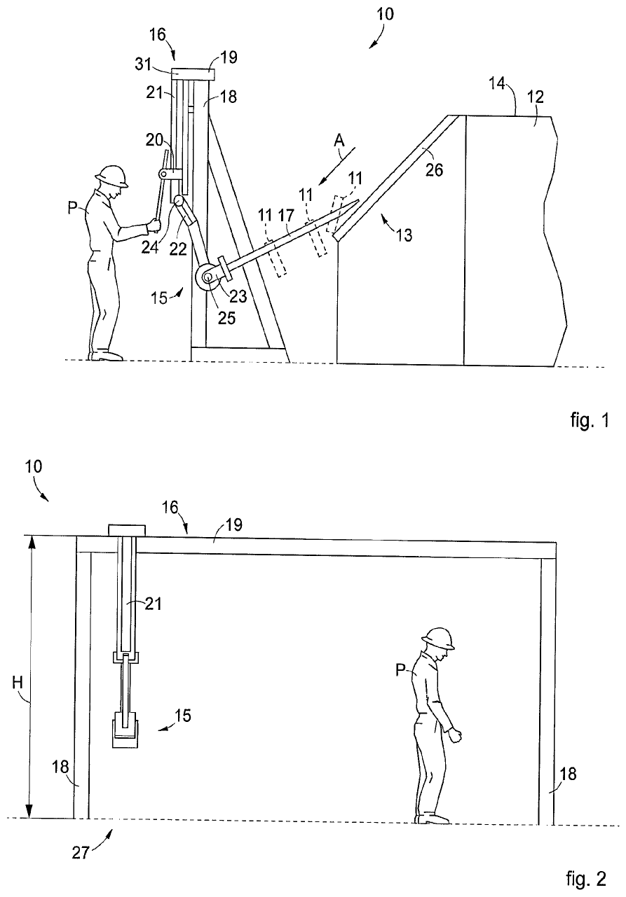

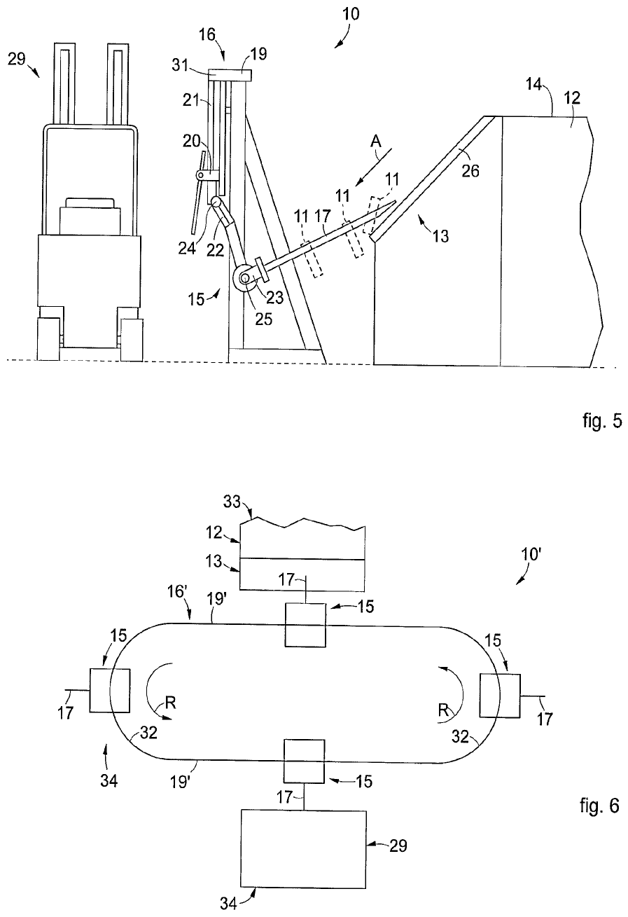

With reference to the attached drawings, see for example FIG. 1, the present invention concerns an apparatus 10 for the collection of metal products 11 from a work machine 12, provided with a transfer zone 13, or pulpit, for the transfer of said metal products 11 from a work plane 14, for example clamping-shaping, to a zone outside said work machine 12 and transfer them to a forklift 29, FIGS. 4 and 5, or other transport or transfer mean, for example a conveyor belt or other.

In a per se known manner, said work machine 12 comprises movement means suitable for bringing the worked metal products 11 towards said zone 13, see arrow A.

Said apparatus 10 comprises at least one device 15 for collecting said metal products 11 which is hanging from a support structure 16 and is provided with one or more arms 17 configured to pick up said metal products 11 directly from said transfer zone 13. If the metal products 11 to be picked up are clamps, for example with square or rectangular shape, such one or more arms 17 fork said clamps from the zone 13. Similarly, the forks of the forklift 29 fork the clamps transferred by said arms 17.

Said arms 17 can also be part of fork, gripper or other systems, depending on the nature and shape of the metal products to be collected.

Said support structure 16 is a portal structure, see for example FIG. 2, comprising at least two columns 18 and a crosspiece 19 from which said collection device 15 is hung, so that during the operations for picking up said metal products 11 it remains raised, so as to operate at the desired height and does not touch the ground.

Said collection device 15 comprises a support 20 mobile along a substantially vertical guide 21 connected to said crosspiece 19. Said support 20 can be raised or lowered along said guide 21 manually by the operator P or an actuator device can be provided that raises and lowers said support 20, actuated for example by said operator P. Said guide 21 is also mobile in a substantially horizontal direction along said crosspiece 19.

Said collection device 15 may further comprise a plurality of sections 22, 23 articulated by means of rotation pins 24, 25, or joints, and configured to allow said arms 17 to vary the inclination with respect to said transfer zone 13 and to the metal products 11 to be picked up.

Said sections 22, 23 can be rotated manually or by means of a suitable actuation device commanded by said operator P.

Thanks to said sections 22, 23, and also to a suitable length of said arms 17, said collection device 15 is configured to pick up said metal products 11 directly from an inclined plane 26 obtained in said transfer zone 13.

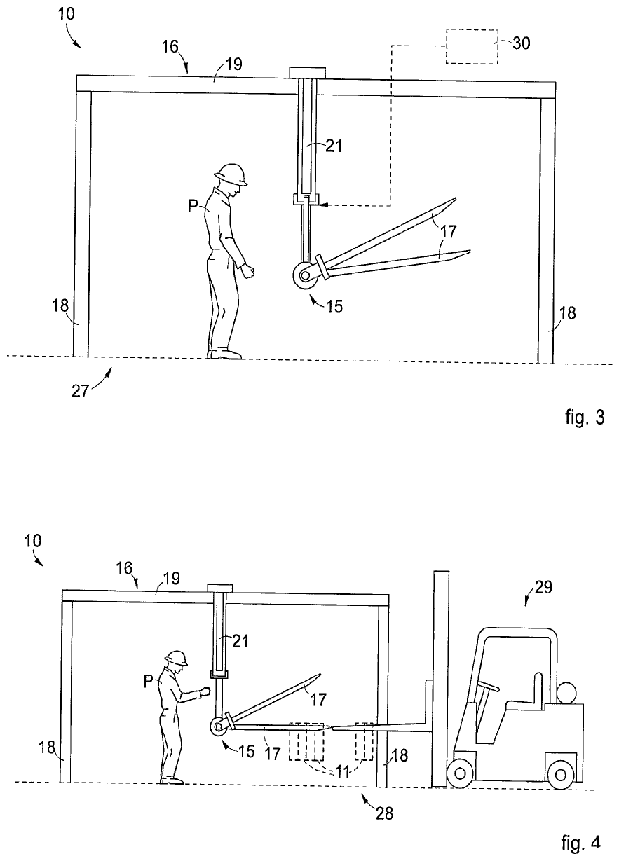

In FIGS. 1 and 3 the collection device 15 is illustrated in an in-line operating position, i.e., in a position where it is able to pick up the metal products 11. Advantageously, however, said support structure 16 comprises at least a first lateral zone 27 in which said collection device 15 can be taken offline, that is, into a non-operating condition, and therefore not interfere with the work area of the work machine 12, see FIG. 2. Said collection device 15 can be transferred from said lateral zone 27 to the operating position, i.e., for example from the situation of FIG. 2 to the situation of FIGS. 1 and 3, or vice versa, by sliding said guide 21 along said crosspiece 19. It is possible to provide that said guide 21 can slide along said crosspiece 19 manually or by means of an actuation device associated with said collection device 15.

Said support structure 15 may further comprise a second lateral zone 28, see FIG. 4, from which it is possible to unload said metal products 11 directly onto said forklift 29 or other transport or transfer mean.

Said first and second lateral zones 27 and 28 may be located on opposite sides of said support structure 15.

Said support structure 15 can have a variable height H, for example from about 2400 to about 3000 mm, so as to be able to use the apparatus 10 efficiently for work machines 12 having variable sizes, in particular relatively to the height of the work plane 14 and of the transfer zone 13. It is possible to choose the height H during the design phase or provide columns 18 in whole or in part telescopic.

Said collection device 15 can be robotised and connected to a control unit 30, FIG. 3. Said control unit 30 can be arranged on the support structure 16 or be positioned elsewhere, also in a remote position with respect to the collection device 15. The robotised collection device 15, for example by means of an anthropomorphic robot hanging from the crosspiece 19 and provided with said arms 17, naturally allows greater automation in collecting said metal products 11. Said arms 17 as said can be part of a gripper system provided to the robot and configured to pick up the metal products 11 and deposit them on a collection container, on the forklift 29, or another transport, collection or transfer system.

Said support structure 16 can furthermore provide an element 31 for the cantilevered support of said collection device 15, see FIG. 5. Said element 31 allows to avoid any interference with the work area of the work machine 12 and with the forklift 29. The support structure 16 can provide, for example, columns 18 with different framing than previously illustrated. It is also possible to provide a plurality of elements 31 for the cantilevered support, for example, in case multiple collection devices 15 are used.

In FIG. 6 a variant of the present apparatus 10′ is schematised in plan, in which the support structure 16′ comprises an overhead rail conveyor, substantially annular in shape and defined for example by two crosspieces 19′ connected by means of curved segments 32. Along said conveyor one or more collection devices 15 can move from a loading zone 33 of metal products 11, which is located at said zone 13 of the work machine 12, to an unloading zone 34 of said metal products 11 by said one or more collection devices 15, which is located at said forklift 29 or other transport or movement mean. Said one or more collection devices 15 can then return toward said loading zone 33 and so on. Said one or more collection devices 15 can move for example in direction R along said conveyor by means of suitable actuation means. For a better operating efficiency of the apparatus 10′ and to optimize the spaces available, the loading and unloading zones 33 and 34 are located on opposite sides of said support structure 16′ and therefore of said overhead rail conveyor.

The present apparatus 10, 10′ is therefore extremely compact, efficient, simple and allows the collection device 15 to pick up the metal products 11 directly from the transfer zone 13 of the work machine 12 and transfer them to the forklift 29 or other transport mean. The present apparatus 10, being hung on the support structure 16, in particular of a portal kind, also does not require electrical power cables or other placed on the ground, therefore the area within which it operates is advantageously clear and does not further interfere with the work area of the work machine 12.

It is clear that modifications and/or additions of parts, or steps, may be made to the apparatus and to the method to collect metal products described so far without thereby departing from the scope of the present invention as defined by the claims.

It is also clear that, although the present invention has been described with reference to some specific examples, a person skilled in the art will be able to make many other equivalent forms of an apparatus for the collection of metal products having the features expressed in the claims and therefore all of which falling within the scope of protection defined thereby.

In the following claims, the references in parentheses have the sole purpose of facilitating reading and must not be considered as limiting factors of the scope of protection defined by the claims themselves.

1. An apparatus (10, 10′) for a collection of products, in particular metal products (11) from a work machine (12), provided with a transfer zone (13) for a transfer of said metal products (11) from a work plane (14) to a zone outside said work machine (12), wherein the apparatus comprises at least one device (15) for collecting said metal products (11) which is hanging from a portal type support structure (16, 16′) and is provided with one or more arms (17) configured to pick up said metal products (11) directly from said transfer zone (13) and transfer them to a forklift (29) or other transport or movement mean.

2. The apparatus (10, 10′) of claim 1, wherein said support structure (16) comprises at least two columns (18) and a crosspiece (19) from which said collection device (15) is hung.

3. The apparatus (10, 10′) of claim 2, wherein said collection device (15) comprises a support (20) mobile along a substantially vertical guide (21) connected to said crosspiece (19).

4. The apparatus (10, 10′) of claim 3, wherein said guide (21) is mobile in a substantially horizontal direction along said crosspiece (19).

5. The apparatus (10, 10′) of claim 1, wherein said collection device (15) comprises a plurality of sections (22, 23) articulated by means of rotation pins (24, 25).

6. The apparatus (10, 10′) of claim 1, wherein said support structure (16) comprises at least a first lateral zone (27) in which said collection device (15) can be taken offline, that is, into a non-operating condition.

7. The apparatus (10, 10′) of claim 1, wherein said support structure (16) comprises at least a second lateral zone (28) from which it is possible to unload said metal products (11) directly onto said forklift (29) or other transport or transfer mean.

8. The apparatus (10, 10′) of claim 1, wherein said support structure (16) comprises one or more elements (31) for cantilevered support of one or more collection devices (15).

9. The apparatus (10, 10′) of claim 1, wherein said collection device (15) is automated and connected to a control unit (30).

10. The apparatus (10, 10′) of claim 1, wherein said support structure (16) has a variable height (H).

11. The apparatus (10, 10′) of claim 1, wherein said support structure (16′) comprises an overhead rail conveyor (19′, 32) on which one or more collection devices (15) are positioned, which are configured to collect said metal products (11) from a first loading zone (33) located in proximity to said transfer zone (13), unload them in an unloading zone (34) located in proximity to said forklift (29), or other transport or movement mean, and then return toward said transfer zone (13).

12. The apparatus (10, 10′) of claim 11, wherein said overhead rail conveyor is annular and substantially defined by at least one pair of crosspieces (19′) connected by means of curved segments (32).

13. A method to collect products, in particular metal products (11), from a work machine (12) which is provided with a transfer zone (13) for a transfer of said metal products (11) from a work plane (14) to a zone outside said work machine (12), the method comprising direct collection of said metal products (11) from said transfer zone (13) by means of one or more arms (17) provided in at least one collection device (15) hanging from a support structure (16, 16′) of an apparatus (10, 10′) for the collection and transfer of said metal products (11) from said collection device (15) to a forklift (29) or other transport or movement mean.
